(19) United States
(12) Patent Application Publication
(10) Pub. No.: US 2006/0145976 A1
(43) Pub. Date: Jul. 6, 2006

(54) Viewing-angle adjustable liquid crystal display and viewing-angle adjusting method thereof

(75) Inventors: Meng-Chang Tsai, Chiayi (TW); Chih-Ming Chang, Taoyuan (TW)

Correspondence Address: BIRCH STEWART KOLASCH & BIRCH, PO BOX 747, FALLS CHURCH, VA, 22040-0747, US

(73) Assignee: AU Optronics Corp.

(21) Appl. No.: 11/118,339

(22) Filed: May 2, 2005

(30) Foreign Application Priority Data
Jan. 3, 2005 (TW) 94100099

(51) Int. Cl. G09G 3/36

(52) U.S. Cl. 345/87

(57) ABSTRACT

A viewing-angle adjustable liquid crystal display includes a backlight module, a first display panel, a second display panel, and a data driver. The first display panel, disposed above the backlight module, includes a first liquid crystal layer and a first pixel electrode corresponding to each pixel. The second display panel, disposed above the first display panel, includes a second liquid crystal layer and a second pixel electrode corresponding to each pixel. The data driver, coupled to the first display panel and the second display panel, is for driving the first pixel electrode and the second pixel electrode corresponding to each pixel.

This application claims the benefit of Taiwan application Serial No. 94100099, filed Jan. 3, 2005, the subject matter of which is incorporated herein by reference.

### BACKGROUND OF THE INVENTION

1. Field of the Invention

The invention relates in general to a viewing-angle adjustable liquid crystal display and viewing-angle adjusting method thereof, and more particularly a liquid crystal, which can achieve viewing-angle adjustment by driving two liquid crystal layers, and viewing-angle adjusting method thereof.

2. Description of the Related Art

As technology makes progress, consumers have more opportunities of using mobile devices equipped with liquid crystal displays, such as mobile phones or notebook computers, in public regions. As using the mobile device in a public region, the consumers often need the mobile device to have a viewing-angle adjustable display so as to keep his/her secret. At present, there are three kinds of well-known liquid crystal display viewing-angle control methods.

FIG. 1 is a schematic diagram of using shutter structure to adjust the liquid crystal display viewing-angle. Referring to FIG. 1, the shutter structure 110 is disposed in front of the liquid crystal display 100 and has the shutters arranged in parallel. By adjusting the height h of the shutter structure 110 and the distance I between two adjacent shutters, the light L emitted by the display 100 can be restricted to reach eyes of the observers at some specific viewing-angles. Therefore, only within the viewing angle region spreading the angle Θ as shown in the figure, the light L can pass the absorbing materials 110 and the observer at these viewing angles can thus see the images on the display 100 while the light L emitted beyond the viewing-angle region of the angle Θ, will be absorbed by the absorbing materials 110.

However, the viewing-angle control method has the following disadvantages. The shutter structure 110, as used, should be additionally configured at the exterior of the display, thereby causing the inconvenience in usage. Since a part of the light L is absorbed by the shutter structure 110, the display luminance will be lowered down at least a half. Moreover, the shutter structure 110 can only provide a left side viewing-angle mode or a right side viewing-angle mode, which will not meet the user's requirement of various view-angle modes, for example, only the users at the front view and the left-side view can observe the displayed images.

FIG. 2A and FIG. 2B are schematic diagrams of using a light scattering device to adjust the liquid crystal display viewing-angle in related art. The light scattering device 210, such as a polymer dispersed liquid crystal (PDLC) layer, in which light scattering features can be adjusted, is disposed between the parallel backlight (Lb) device (not shown in the figure) and the liquid crystal cell 200. By adjusting the voltage applied to the light scattering device 210, the narrow viewing-angle mode and the wide viewing-angle mode can be provided. As shown in FIG. 2A, under the narrow viewing-angle mode, the light scattering device 210 is in the power on state, and appears transparent so that the backlight Lb is maintained parallel after passing the light scattering device 210 to reach the liquid crystal cell 200. Therefore, only the front view observer can see the displayed images. As shown in FIG. 2B, under the wide viewing-angle mode, the light scattering device 210 is in the power off state, the backlight Lb is scattered to form the scattering light Ls and enter the liquid crystal layer 200 so that the observers at every viewing angle can see the displayed images.

However, this viewing angle control method has the following disadvantages. When the light scattering device 210 is switched to the power on state, a part of the backlight Lb will be reflected as passing the light scattering device 210, thereby reducing the luminance of the liquid crystal panel 200. In addition, as the above-mentioned example, this viewing angle control method can only provide the narrow viewing angle mode for front view observers, but not for the user at any other viewing angle, thereby reducing the available options in viewing-angle adjusting.

FIG. 3A and FIG. 3B are schematic diagrams of controlling viewing angles by using an extra alignment layer in the related art. By adjusting the rubbing direction of the alignment layer additionally disposed on the liquid crystal display, a wide-viewing-angle mode and a narrow-viewing-angle mode can be provided. As shown in FIG. 3A, under the narrow-viewing-angle mode, the front view observer can see the displayed image 300 while the side view observer cannot distinguish the display image 300 for a specific picture 310 having bright and dark stripes in turn covers the image 300 as shown in FIG. 3B. By doing so, the viewing-angle adjusting purpose can be achieved.

However, as shown in the above-mentioned three examples, the present viewing-angle adjustable liquid crystal display structures have the disadvantage of the luminance and bright contrast deviation as the viewing angle modes are switched. Also they cannot provide the narrow-viewing-angle mode for users at other viewing-angles except the front view ones. Therefore, such viewing angle adjusting methods are not satisfied.

### SUMMARY OF THE INVENTION

It is therefore an object to provide a viewing-angle adjustable liquid crystal display and viewing-angle adjusting method thereof. The liquid crystal display has two liquid crystal layers. When the liquid crystal display operates at the wide-viewing-angle mode, one of the two liquid crystal layers is driven such that the passing backlight has zero phase delay, and the other liquid crystal is controlled such that the passing backlight has the required phase delay for data or image display. When the liquid crystal display operates at the narrow-viewing-angle mode, two liquid crystal layers are driven so that the passing backlight at the front view has a different phase delay from that backlight at the side view, thereby providing the effect of viewing-angle adjustability.

The invention achieves the above-identified object by providing a viewing-angle adjustable liquid crystal display including a backlight module, a first display panel, a second display panel, and a data driver. The backlight module is for generating backlight. The first display panel, disposed above the backlight module, includes a first upper substrate, a first lower substrate, and a first liquid crystal layer. The first lower substrate has a number of first pixel electrodes corresponding to a number of pixels. The first liquid crystal layer is disposed between the first upper substrate and the first lower substrate. The second display panel, disposed above the first display panel, includes a second upper substrate, a second lower substrate, and a second liquid crystal layer. The second lower substrate has a number of second pixel electrodes corresponding to the pixels. The second liquid crystal layer is disposed between the second upper substrate and the second lower substrate. The data driver, coupled to the first display panel and the second display panel, is for driving the first pixel electrodes and the second pixel electrodes corresponding to the pixels. The data driver drives the first pixel electrodes corresponding to the pixel with a gray level voltage according to a wide-viewing-angle-mode signal and drives the first pixel electrodes corresponding to the pixels with a first pixel voltage to display the required pixel images in a declined direction relative to the first display panel according to a narrow-viewing-angle-mode signal.

The invention achieves the above-identified object by providing a method for adjusting a viewing-angle of a liquid crystal display. The method includes driving the first pixel electrodes corresponding to the pixels with a gray level voltage according to a wide-viewing-angle-mode signal; and driving the first pixel electrodes corresponding to the pixels with a pixel voltage according to a narrow-viewing-angle-mode signal to display pixel images corresponding to the pixels in a declined direction.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of using shutter structure to adjust the liquid crystal display viewing-angle.

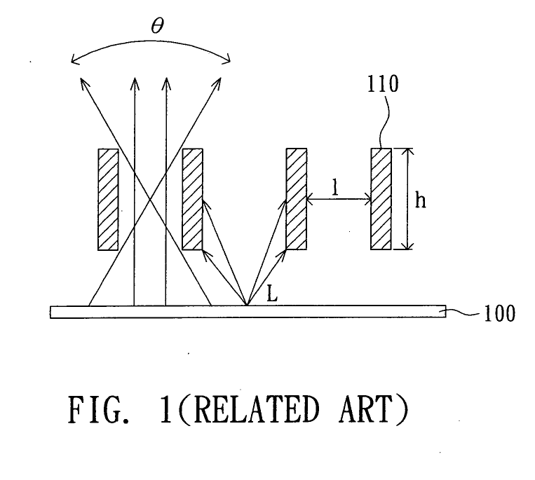

FIG. 2A and FIG. 2B are schematic diagrams of using light scattering device to adjust the liquid crystal display viewing-angle.

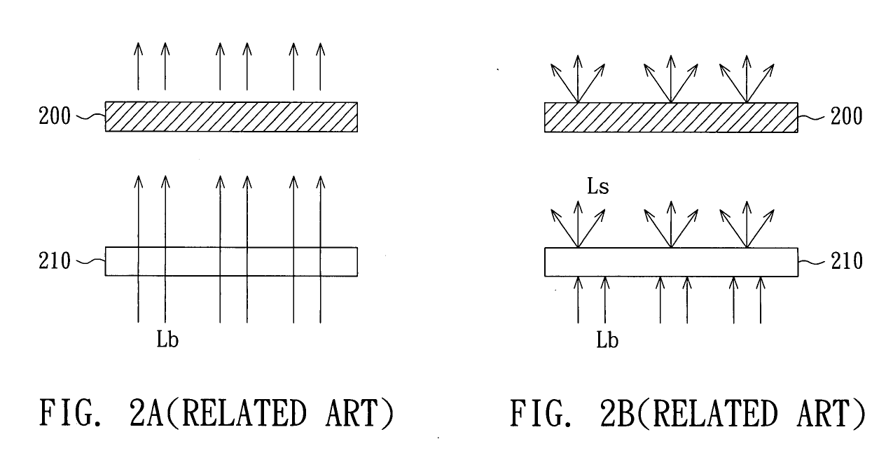

FIG. 3A and FIG. 3B are schematic diagrams of controlling viewing angles by using an extra alignment layer.

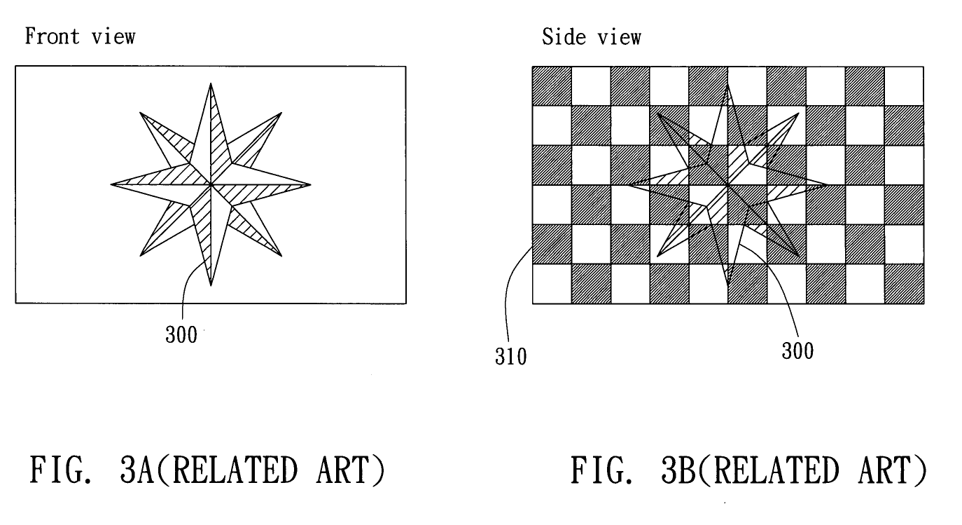

FIG. 4A is a block diagram of the liquid crystal display according to a preferred embodiment of the invention.

FIG. 4B is a partial schematic diagram of the liquid crystal display according to a preferred embodiment of the invention.

FIG. 5A and FIG. 5B are simplified cross-sectional diagrams of the liquid crystal display operating at the wide-viewing-angle mode according to a first example of the invention.

FIG. 5C and FIG. 5D are simplified cross-sectional diagrams of the liquid crystal display operating at the narrow-viewing-angle mode according to a first example of the invention.

FIG. 5E and FIG. 5F are schematic diagrams of the backlight path in the liquid crystal display of FIG. 5D respectively with the backlight oriented to side-view angles 45 degree and 60 degree.

FIG. 6A and FIG. 6B are simplified cross-sectional diagrams of the liquid crystal display operating at the narrow-viewing-angle mode according to a second example of the invention.

FIG. 7A and FIG. 7B are simplified cross-sectional diagrams of the liquid crystal display operating at the narrow-viewing-angle mode according to a third example of the invention.

FIG. 8 is a flow chart of the method for adjusting the viewing-angle of the liquid crystal display according to the preferred embodiment of the invention.

### DETAILED DESCRIPTION OF THE INVENTION

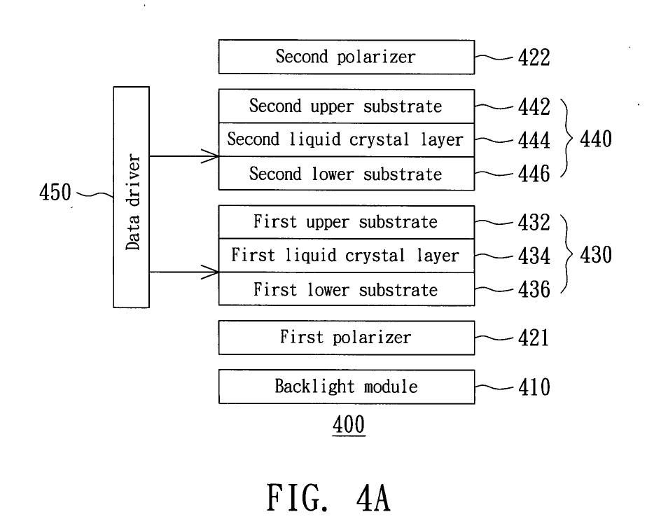

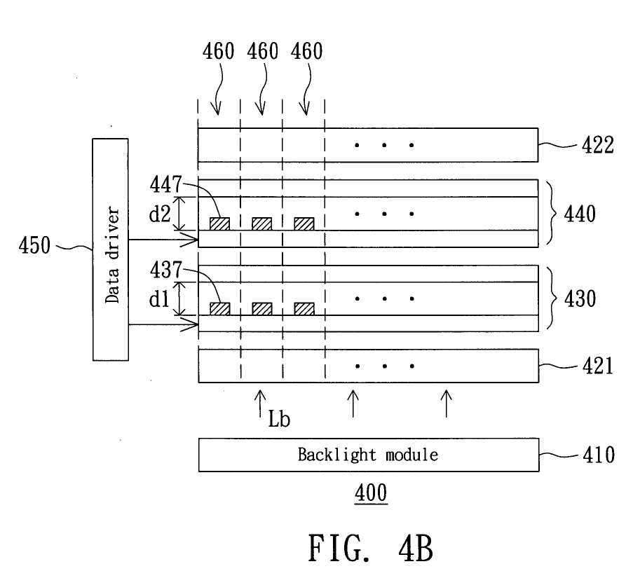

Referring to FIG. 4A and FIG. 4B, a block diagram and a partial schematic diagram of the liquid crystal display according to a preferred embodiment of the invention are respectively shown. The liquid crystal display 400 includes a backlight module 410, a first polarizer 421, a first display panel 430, a second display panel 440, a second polarizer 422, and a data driver 450. The first display panel 460 and the second display panel 440 are disposed above the backlight module 410 and between the first polarizer 421 and the second polarizer 422. The second display panel 440 is disposed above the first display panel 430. The first display panel 430 includes a first upper substrate 432, a first liquid crystal layer 434, and a first lower substrate 436. The first liquid layer 434 is disposed between the first upper substrate 432 and the first lower substrate 436. The second display panel 440 includes a second upper substrate 442, a second liquid crystal layer 444, and a second lower substrate 446. The second liquid crystal layer 444 is disposed between the second upper substrate 442 and the second lower substrate 446.

The backlight emitted from the backlight module 410 passes the first polarizer 421 first, goes through the first display panel 430 and the second display panel 440, and then enters the observer's eye. As shown in FIG. 4B, the first lower substrate 436 of the first display panel 430 has a first pixel electrode corresponding to the pixel 460, while the second lower substrate 446 of the second display panel 440 has a second pixel electrode corresponding to the pixel 460. The data driver 450, coupled to the first display panel 430 and the second display panel 440, is for respectively outputting a first pixel voltage V1 and a second pixel voltage V2 to the first pixel electrode 437 and the second pixel electrode 447. The first pixel voltage V1 and the second pixel voltage V2 respectively drive the liquid crystals of the first liquid crystal layer 434 and the second liquid crystal layer 444 to rotate to generate the required wide-viewing-angle mode and narrow-viewing-angle mode.

The polarizing angles of the above-mentioned first polarizer 421 and second polarizer 422 differ by 90 degrees. The total phase delay of the backlight as passing through the first liquid crystal layer 434 and the second liquid crystal layer 444 can be controlled by the first pixel voltage V1 and the second pixel voltage V2 inputted to the first pixel electrode 437 and the second pixel electrode 447 by the data driver 450. The total phase delay is represented by And, which is equal to the sum of the phase delay (Δnd1) generated by the first liquid crystal layer 434 and the phase delay (Δnd2) generated by the second liquid crystal layer 444, wherein Δn is the refractive index difference between the long axis and short axis of the liquid crystal, and d1, d2 are respectively the thickness of the liquid crystal layers 434 and 444. If the value Δnd is zero, it means that the backlight passing the liquid crystal layers 434 and 444 has no phase delay. Since the polarizing directions of the polarizers 421 and 422 are perpendicular, the backlight Lb passing the first polarizer 421 will be absorbed by the second polarizer 422, and thus the observer can just see the dark pixels. If the value Δnd is a half of the backlight wavelength λ, that is, the backlight passing the liquid crystal layers 434 and 444 has a 90-degree phase delay, the backlight Lb can go through the second polarizer 422 and thus the observer can see bright pixels 460 due to the polarizers 421 and 422.

In the following description, the vertical alignment (VA) type liquid crystal display is taken for illustration, and three examples are taken to explain how the liquid crystal display of the invention generates the wide-viewing-angle mode and the narrow-viewing-angle mode to achieve the viewing-angle adjusting purpose with reference to the accompanying drawings. Moreover, in the drawings the pixels having zero phase delay are represented by blank grids, the pixels having λ/8 phase delay are represented by grids of dense slashes, the pixels having λ/4 phase delay are represented by grids of sparse slashes, and the pixels having λ/2 phase delay are represented by grids of dots.

### EXAMPLE ONE

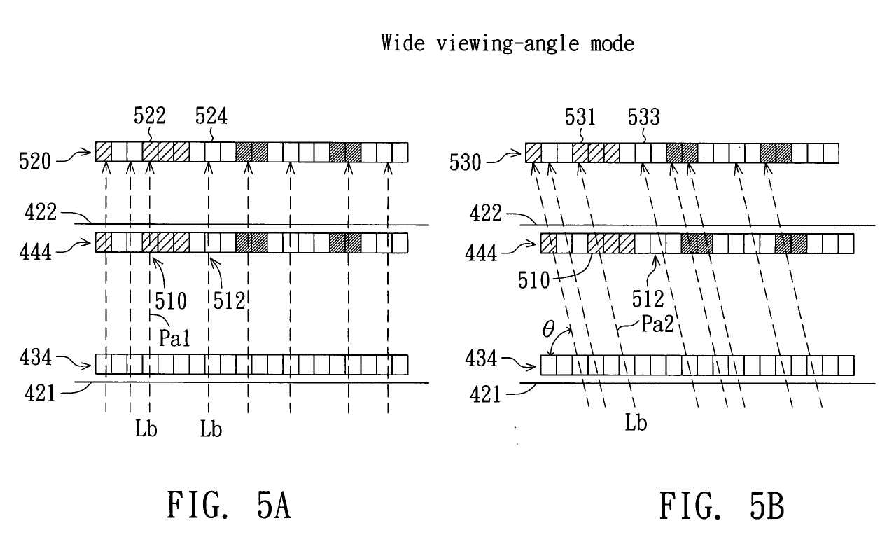

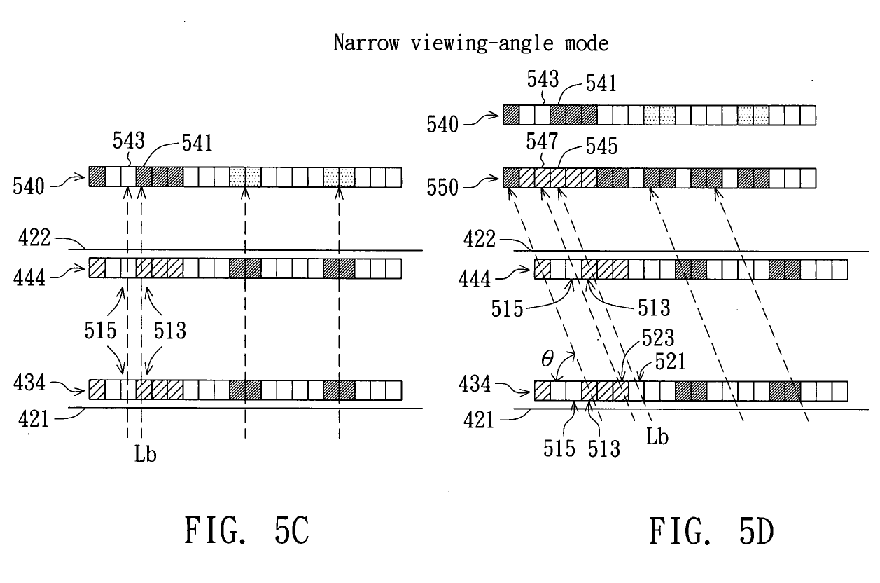

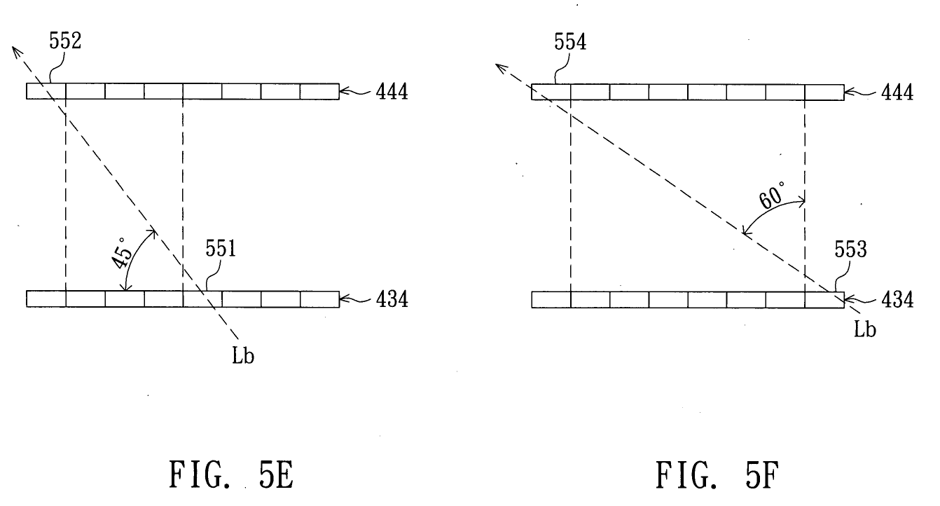

Referring to FIG. 5A and FIG. 5B, simplified cross-sectional diagrams of the liquid crystal display operating at the wide-viewing-angle mode according to a first example of the invention are shown. In order to operate the liquid crystal display 400 at the wide-viewing-angle mode, the whole first liquid crystal layer 434 can be driven such that the passing backlight has zero phase delay Δnd1. For example, when the first pixel voltage is set to 0V, the liquid crystals of the first liquid crystal layer 434 are in an upstanding state. The backlight Lb passes the first liquid crystal layer 434 without phase delay before entering the second liquid crystal layer 444, and the displayed information is determined completely by driving the second liquid crystal layer 444. Of course, the second liquid crystal layer 444 can also alternatively driven such that the passing backlight has zero phase delay Δnd2, and the displayed information is determined completely by driving the first liquid crystal layer 434.

As shown in FIG. 5A, in terms of a front-view observer, the backlight passing the second liquid crystal layer 444 corresponding to the pixel 510 has λ/8 phase delay Δnd2, and thus the total phase delay Δnd of the backlight Lb emitted from the pixel 510 is λ/8 (0+λ/8). Therefore, the front-view observer can see bright pixels (grids of dense slashes) 522 of the frame 520. Furthermore, the backlight passing the second liquid crystal layer corresponding to the pixel 512 has zero phase delay Δnd2, and thus the total phase delay Δnd of the backlight Lb emitted from the pixel 510 is 0 (0+0). Therefore, the front-view observer can see dark pixels (blank grids) 524 of the frame 520.

As shown in FIG. 5B, the backlight Lb reaching the side-view observer has an included angle θ with the liquid crystal layers 434 and 444, and the backlight passing the second liquid crystal 444 layer corresponding to the pixel 510 has λ/8 phase delay Δnd2. Although the backlight emitted out of the pixel 510 has a path Pa2 different from the path Pa1 of the backlight Lb oriented to the front-view, since the phase delay Δnd1 generated by the liquid crystal layer 434 is zero, the total phase delay Δnd of the backlight at the side-view is equal to λ/8 (0+λ/8), the same as that of the backlight at the front-view. That is, the side-view observer can see bright pixels 531 of the frame 530, similar to the bright pixels 522 of the front-view frame 520. In the same situation, the backlight at the side-view passing the second liquid crystal layer 444 corresponding to the pixel 512 results in a dark pixel 533 observation of the side-view frame 530, similar to the dark pixel 524 of the front-view frame 520. Therefore, the phase delay of the backlight in the side-view frame 530 can be determined by the second liquid crystal layer 444. The side-view observer can see frame 530 having bright and dark pixels in turn, the same as the frame 520 having bright and dark pixels in turn, and thus both of the front-view and side-view observers can observe the correct information on the display 400.

Referring to FIG. 5C and FIG. 5D, simplified cross-sectional diagrams of the liquid crystal display operating at the narrow-viewing-angle mode according to a first example of the invention are shown. In order to operate the liquid crystal display 400 at the narrow-viewing-angle mode, the first liquid crystal layer 434 and the second liquid crystal layer 444 can be driven such that the backlight at the front-view passes the liquid crystal layers 434 and 444 corresponding to a certain pixel to have the same phase delay Δnd1 and Δnd2, and the total phase delay Δnd is only a half of the phase delay of the backlight in the required frame 540 regarding to the pixels. In other words, the first phase delay and the second phase delay of a parallel backlight Lb generated as passing the first liquid crystal layer 434 and the second liquid crystal layer 444 with regard to each pixel has a constant ratio. For example, the first liquid crystal layer 434 and the second liquid crystal layer 444 corresponding to the pixel 513 can be driven such that the passing backlight has the phase delay Δnd1 and Δnd2 of both λ/8 and totally λ/4 in order to generate a bright pixel 541 of the required frame 540. In the same reason, the phase delay Δnd1 and Δnd2 of the backlight passing the liquid crystal layers 434 and 444 corresponding to the pixel 515 is both 0, so the front-view observer can see a dark pixel 543 of the frame 540.

On the other hand, as shown in FIG. 5D, for the two liquid crystal layers 434 and 444 are separated by a distance D, the backlight reaching the side-view observer having an included angle with the liquid crystal layer 434, passes a path different from that of the backlight at the front-view, thereby causing a different phase delay. The backlight Lb passing the second liquid crystal layer 444 corresponding to the pixel 513 emits out of the first liquid crystal layer 434 corresponding to the pixel 521 (a blank grid), so the total phase delay Δnd of the backlight corresponding to the pixel 545 of the side-view frame 550 is λ/8 (0+λ/8). In the same reason, the backlight Lb passing the second liquid crystal layer 444 corresponding to the pixel 515 emits out of the first liquid crystal layer 434 corresponding to the pixel 523, so the total phase delay Δnd of the backlight corresponding to the pixel 547 of the side-view frame 550 is λ/8 (λ/8+0).

Referring to FIG. 5E and FIG. 5F, schematic diagrams of the backlight path in the liquid crystal display of FIG. 5D respectively with the backlight oriented to side-view angles 45 degree and 60 degree are shown. Taking 15-inch display panels 430 and 444 as an example, the width of each pixel is about 0.3 mm, and the distance between the liquid crystal layers 434 and 444 is about 1.4 mm, the thickness of two glasses respectively disposed in the layers 434 and 444. When the second display panel 440 is observed at a 45 degree side view, the backlight passing from the liquid crystal layer 434 to the layer 444 goes a parallel distance of 1.4×(tan45°)=1.4 mm. As shown in FIG. 5E, the backlight goes three pixels in parallel as passing from the pixel 551 of the layer 443 to the pixel 552 of the layer 444. On the other hand, when the panel 420 is observed from the 60 degree side view, the backlight goes six pixels in parallel as passing from the pixel 553 of the layer 434 to the pixel 554 of the layer 444 as shown in FIG. 5F. Therefore, the larger the side-view angle is, the more distant the backlight passes, and the more unclear is the observed image. Therefore, in terms of a constant distance D, the larger is the side-view angle, the more unclear is the observed picture while in terms of a constant viewing angle, the larger is the distance D, the more unclear frame is seen by the observed.

In addition, when the liquid crystal display 400 is switched to the narrow viewing angle mode, the phase delay Δnd1 and Δnd2 generated by the liquid crystal layers 434 and 444 corresponding to a certain pixel can have other ratio, such as 1:2 in addition to the above-mentioned ratio 1:1. In the case of 1:2, the thorough bright pixel generated by the backlight having phase delay Δnd of λ/4 can be given by the backlight having a phase delay of λ/12 through one liquid crystal layer and a phase delay of λ/6 through the other liquid crystal layer. Therefore, by changing the ratio, a variety of viewing angles can be provided for the observer.

### EXAMPLE TWO

The second example provides the method for driving the wide viewing-angle mode the same with that in the first example, but the method for driving liquid crystal layers 434 and 444 at the narrow viewing-angle mode different from that in the first one.

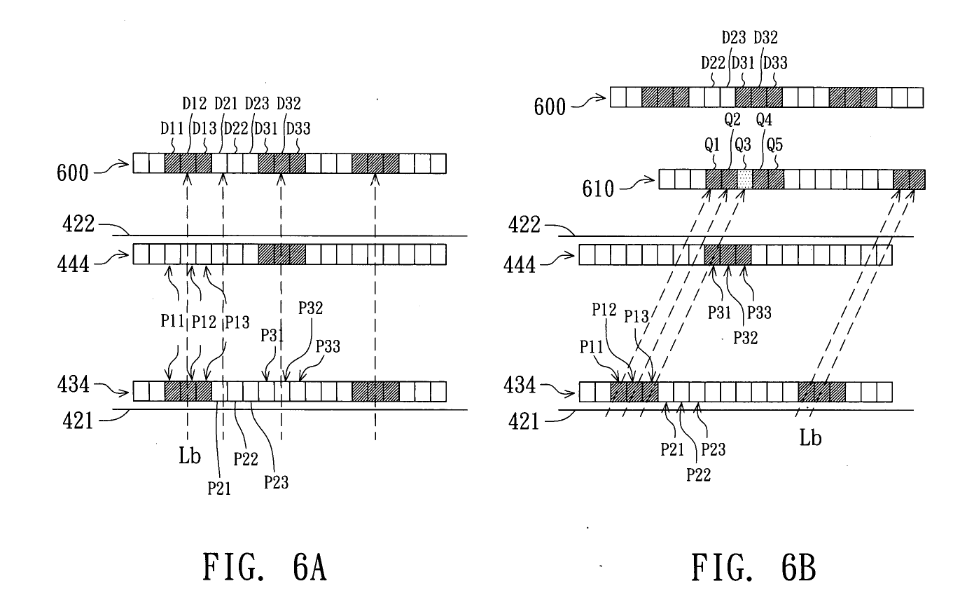

Referring to FIG. 6A and FIG. 6B, simplified cross-sectional diagrams of the liquid crystal display operating at the narrow viewing-angle mode according to a second example of the invention are shown. In order to operate the liquid crystal display 400 at the narrow viewing-angle mode, the to-be-displayed information can be generated by the backlight passing the first liquid crystal layer 434 and the second liquid crystal layer 444. When the display 400 is observed at the front view, as shown in FIG. 6A, the phase delay Δnd1 and Δnd2 of the backlight passing the liquid crystal layers 434 and 444 corresponding to the successive pixels P11, P12, P13 are all respectively λ/4 and 0. Therefore, the phase delay Δnd corresponding to the pixels D11, D12, and D13 of the frame 600 seen by the observer is λ/4 (λ/4+0), and thus bright pixels D11, D12, and D13 can be observed. In the same reason, the phase delay Δnd1 and Δnd2 of the backlight passing the liquid crystal layers 434 and 444 corresponding to the successive pixels P21, P22, P23 are all respectively 0 and 0. The total phase delay Δnd is 0 (0+0). Therefore, the dark pixels D21, D22, and D23 of the front-view frame 600 can be observed. Moreover, the phase delay Δnd1 and Δnd2 of the backlight passing the liquid crystal layers 434 and 444 corresponding to the successive pixels P31, P32, P33 are all respectively 0 and λ/4. The total phase delay And is λ/4 (O+λ/4). Therefore, the bright pixels D31, D32, and D33 of the front-view can be observed. The front-view observer can see the frame 600 having bright and dark pixels in turn, which is to-be-displayed correct information, superimposed partially by the liquid crystal layer 434 and partially by the liquid crystal layer 444.

When the display 400 is observed at the side view, for the path of the backlight Lb is different from that of the backlight at the front view, the different phase delay result can be generated. The backlight passing the liquid crystal layer 444 corresponding to the pixels P22, P23, P31, P32, and P33 emits out of the liquid crystal layer 434 corresponding to the pixels P11, P12, P12, P21, and P22. The phase delay Δnd1 of the backlight passing the layer 434 is respectively λ/4, λ/4, λ/4, 0, and 0, while the phase delay Δnd2 is respectively λ/4, λ/4, λ/2, λ/4, and λ/4. Therefore, the bright pixels Q1, Q2, Q3, Q4, and Q5 of the frame 610 can be seen by the side-view observer. The pixel Q3 brighter than pixels Q1 and Q2 is represented by a grid of dots. Obviously, the pixels Q1˜Q5 of the side-view frame 610 has different brightness as corresponded to the pixels D22, D23, D31, D32, and D33 of the front-view frame 600.

### EXAMPLE THREE

The third example provides the method for driving the wide viewing-angle mode the same with that in the first example, but the method for driving liquid crystal layers 434 and 444 at the narrow viewing-angle mode different from that in the first one.

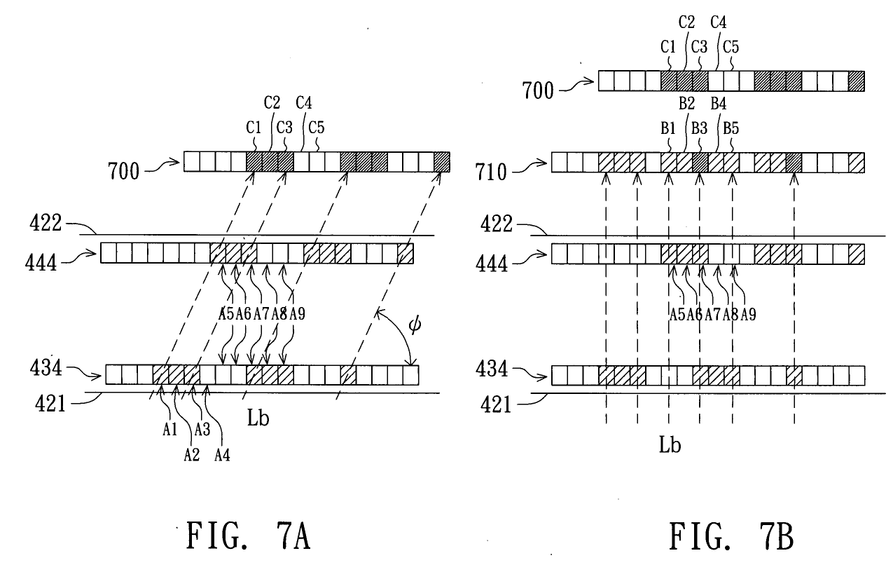

Referring to FIG. 7A and FIG. 7B, simplified cross-sectional diagrams of the liquid crystal display operating at the narrow viewing-angle mode according to a third example of the invention are shown. In the narrow viewing-angle mode, for the Ø degree right side-view observer, the reaching backlight Lb has an included angle Ø with the liquid crystal layers 434 and 444, and the backlight Lb passing the liquid crystal layer 444 corresponding to the successive pixels A5˜A9 emits out of the liquid crystal layer 434 corresponding to the pixels A1˜A5. The phase delay Δnd1 of the backlight passing the layer 434 is respectively λ/8, λ/8, λ/8, 0, and 0, the phase delay Δnd2 is respectively λ/8, λ/8, λ/8, 0, and 0, and thus the total phase delay Δnd is respectively λ/4, λ/4, λ/4, 0, and 0. Therefore, the pixels C1˜C5 of the observed right side-view frame 700, which is supposed to be the correct frame, are respectively bright, bright, bright, dark, and dark. The phase delay Δnd1 and Δnd2 can have other ratios, such as 1:2 in addition to the ratio 1:1. In the case of 1:2, the values Δnd1 are respectively λ/12, λ/12, λ/12, 0, and 0 while the values Δnd2 are respectively λ/6, λ/6, λ/6, 0, and 0.

On the other hand, as shown in FIG. 7B, in terms of the front-view observer, the phase delay Δnd1 and Δnd2 of the backlight passing the liquid crystal layers 434 and 444 corresponding to the pixels A5˜A9 are respectively 0, 0, λ/8, λ/8, λ/8, and λ/8, λ/8, λ/8, 0, 0, with the total phase delay Δnd of λ/8, λ/8, λ/4, λ/8, λ/8. As a result, the pixels B1˜B5 of the observed front-view frame 710 are respectively semi-bright, semi-bright, full bright, semi-bright, and semi-bright, which has obviously very different bright and dark pixel distribution from that of the correct frame 700 seen by the right side-view observer. No matter at the front view or the left side view, the observer will observe an unclear image frame. Therefore, by independently driving the two liquid crystal layers 434 and 444, the suitable phase delays of the backlight passing the layers 434 and 444 can be adjusted according to different viewing angles, thereby achieving the purpose of viewing-angle adjustability.

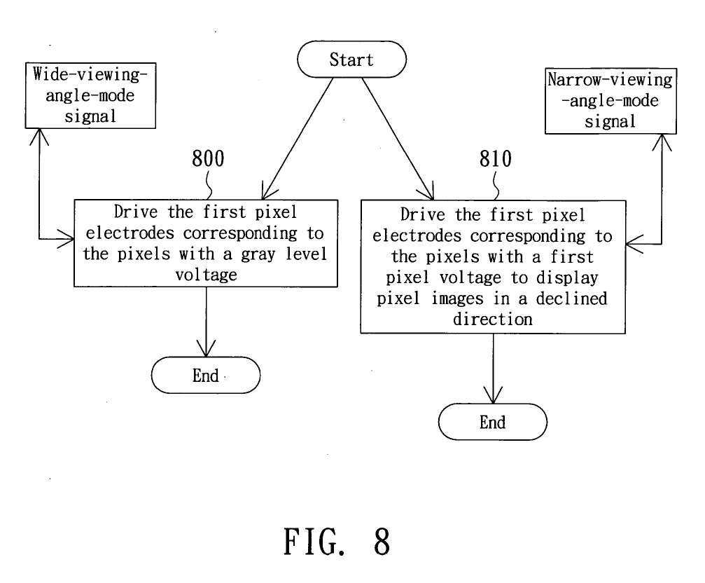

Referring to FIG. 8, a flow chart of the method for adjusting the viewing-angle of the liquid crystal display according to the preferred embodiment of the invention is shown. First, in step 800, drive the first pixel electrodes 437 corresponding to the pixels 460 with a gray level voltage, for example, a 0V driving voltage, to display pixel images via the first display panel 430 or the second display panel 440 according to a wide-viewing-angle-mode signal. As shown in the first example, the front-view and the side-view observers can both see the correct frame information. In step 810, drive the first pixel electrodes 437 corresponding to the pixels 460 with a first pixel voltage V1, for example, a 5V driving voltage, according to a narrow-viewing-angle-mode signal to display pixel images corresponding to the pixels 460 in a declined direction relative to the first display panel 430. As shown in the first example, the first pixel electrodes 437 and 447 corresponding to the same pixel 460 are driven with the same pixel voltage of V1 and V2, and the frame 540 is displayed in the front-view direction vertical to the display panels 430 and 440. As a result, the side-view observer will see incorrect frame 550.

As shown in the second example, one of the first pixel voltage and the second pixel voltage is a normal pixel voltage, for example, 5V, while the other is a gray level voltage, for example, 0V, the to-be-displayed frame 600 is generated in the direction vertical to the display panels 430 and 440. In this case, the side-view observer will see an incorrect frame 610.

As shown in the third example, the first pixel electrode 437 and the corresponding second pixel electrode 447 in a direction declined 0 degrees from the vertical of the display panels 430 and 440 are driven with the same first pixel voltage V1 and second pixel voltage V2 and the to-be-displayed frame 700 is observed by the 0 degree side-view observer. As a result, the front-view observer will see an incorrect frame 710. Therefore, all these cases can provide the required narrow-viewing-angle mode.

As described above, although the VA type liquid crystal display is taken as an example, the liquid crystal display of the invention can also be a twisted nematic (TN) type display or an in-plane switching (IPS) display. Since the total phase delay of the backlight reaching the front-view and the side-view observers can be made different by driving the two liquid crystal layers, the purpose of the viewing-angle adjustability can be achieved. Therefore, it will not be apart from the skill scope of the invention.

The liquid crystal display disclosed by the preferred embodiment of the invention has the following advantages. An extra liquid crystal layer is added in the normal display. By driving the liquid crystals of the two liquid crystal layers, the phase delay of the backlight passing the two liquid crystal layers can be adjusted to generate the required wide viewing-angle mode and the narrow viewing-angle having various viewing angles, thereby achieving the purpose of real viewing-angle adjustability.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A viewing-angle adjustable liquid crystal display, comprising:
a backlight module, for generating backlight;
a first display panel, disposed above the backlight module, comprising:
a first upper substrate;
a first lower substrate, having a plurality of first pixel electrodes corresponding to a plurality of pixels; and
a first liquid crystal layer, disposed between the first upper substrate and the first lower substrate;
a second display panel, disposed above the first display panel, comprising:
a second upper substrate;
a second lower substrate, having a plurality of second pixel electrodes corresponding to the plurality of pixels; and
a second liquid crystal layer, disposed between the second upper substrate and the second lower substrate; and
a data driver, coupled to the first display panel and the second display panel, for driving the first pixel electrodes and the second pixel electrodes corresponding to each pixel;
wherein the data driver drives the first pixel electrodes corresponding to the pixels with a gray level voltage according to a wide-viewing-angle-mode signal and drives the first pixel electrodes corresponding to the pixels with a first pixel voltage to display required pixel images in a declined direction according to a narrow-viewing-angle-mode signal.

2. The liquid crystal display according to claim 1, wherein the data driver drives the first electrodes corresponding to the pixels with the gray level voltage such that a first phase delay or a second phase delay of the backlight passing through the first liquid crystal layer or the second liquid crystal layer, respectively, is zero.

3. The liquid crystal display according to claim 1, wherein data driver drives the first pixel electrodes corresponding to the pixels with the first pixel voltage to display the required pixel images in the declined direction relative to the first display panel such that a ratio, of a first phase delay of the backlight in the declined direction passing through the first liquid crystal layer to a second phase delay of the backlight in the declined direction passing through the second liquid crystal layer, is substantially constant.

4. The liquid crystal display according to claim 3, wherein the ratio is 1:1.

5. The liquid crystal display according to claim 1, wherein the data driver provides a second pixel voltage for driving the second pixel electrodes corresponding to the pixels according to the narrow-viewing-angle-mode signal.

6. The liquid crystal display according to claim 1, wherein the data driver provides a gray level voltage for driving the second pixel electrodes corresponding to the pixels according to the narrow-viewing-angle-mode signal.

7. The liquid crystal display according to claim 1, wherein the declined direction is vertical to the first display panel.

8. The liquid crystal display according to claim 1, wherein the distance between the first liquid crystal layer and the second liquid crystal layer is about smaller than 2 millimeters.

9. The liquid crystal display according to claim 1, wherein the liquid crystal display is a vertical alignment type liquid crystal display.

10. The liquid crystal display according to claim 1, wherein the liquid crystal display is a twisted nematic type liquid crystal display.

11. The liquid crystal display according to claim 1, wherein the liquid crystal display is an in-plane switching liquid crystal display.

12. A method for adjusting a viewing-angle of a liquid crystal display, the liquid crystal display comprising a backlight module for generating backlight, a first display panel and a second display panel, the first display panel comprising a plurality of first pixel electrodes corresponding to a plurality of pixels, the second display panel comprising a plurality of second pixel electrodes corresponding to the pixels, the method comprising:
driving the first pixel electrodes corresponding to the pixels with a gray level voltage to display pixel images according to a wide-viewing-angle-mode signal; and
driving the first pixel electrodes corresponding to the pixels with a pixel voltage according to a narrow-viewing-angle-mode signal to display pixel images corresponding to the pixels in a declined direction.

13. The method according to claim 12, further comprising driving the second pixel electrodes corresponding to the pixels with the pixel voltage according to the narrow-viewing-angle-mode signal.

14. The method according to claim 12, further comprising driving the second pixel electrodes corresponding to the pixels with the gray level voltage according to the narrow-viewing-angle-mode signal, wherein the gray level voltage is smaller than the pixel voltage.
